(19) United States
(12) Patent Application Publication
(10) Pub. No.: US 2011/0069121 A1
(43) Pub. Date: Mar. 24, 2011

(54) INKJET PRINTHEAD AND METHOD OF MANUFACTURING THE SAME

(75) Inventors: Byung-Ha Park, Suwon-si (KR); Young-Ung Ha, Suwon-si (KR)

(73) Assignee: SAMSUNG ELECTRONICS CO., LTD., Suwon-si (KR)

(21) Appl. No.: 12/722,346

(22) Filed: Mar. 11, 2010

(30) Foreign Application Priority Data
Sep. 22, 2009 (KR) 10-2009-0089648

(51) Int. Cl. B41J 2/14; B32B 38/04; B41J 2/16; B41J 2/145

(52) U.S. Cl. 347/47; 156/253

(57) ABSTRACT

The present disclosure provides an inkjet printhead and a method of manufacturing the inkjet printhead. The inkjet printhead includes: a substrate having an ink feed hole; a chamber layer disposed on the substrate, the chamber layer including a plurality of ink chambers that may be filled with ink supplied through the ink feed hole; a nozzle layer disposed on the chamber layer, the nozzle layer including a plurality of nozzles through which ink is ejected; and a glue layer disposed between the substrate and the chamber layer. The glue layer includes a cured product of an oxetane resin composition.

### CROSS-REFERENCE TO RELATED PATENT APPLICATION

This application claims the benefit of Korean Patent Application No. 10-2009-0089648, filed on Sep. 22, 2009, in the Korean Intellectual Property Office, the disclosure of which is hereby incorporated by reference in its entirety for all purposes.

### TECHNICAL FIELD

The present disclosure relates to an inkjet printhead and method of manufacturing the same.

### BACKGROUND OF RELATED ART

Inkjet printheads are devices for printing images on a printing medium by ejecting droplets of ink onto the desired regions of the printing medium. Inkjet printheads can be classified broadly into two different types depending on the mechanism, of ejecting ink droplets: piezoelectric inkjet printheads and thermal inkjet printheads. For piezoelectric inkjet printheads, a piezoelectric crystal may be deformed and the pressure due to the deformation of the piezoelectric crystal causes ink droplets to be ejected from the printhead. In contrast, in thermal inkjet printheads, ink may be heated to form ink bubbles and the expansive force of the bubbles causes ink droplets to be ejected from the printhead nozzles.

Thermal inkjet printheads typically contain a chamber layer and a nozzle layer that may be sequentially stacked together. In this regard, a plurality of ink chambers, which are filled with ink to be ejected, are formed in the chamber layer, and a plurality of nozzles through which ink may be ejected are formed in the nozzle layer.

### SUMMARY OF THE DISCLOSURE

Aspects of the present disclosure provides an inkjet printhead and method for manufacturing the inkjet printhead.

In one aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, and wherein the oxetane resin composition includes an oxetane resin, a cationic photoinitiator, a solvent, and an adhesion improving agent.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the oxetane resin may be represented by Formula 1:

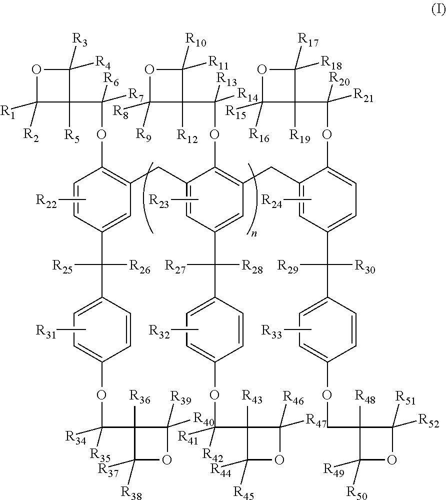

where n may be an integer from 1 to 20; and R₁ through R₅₂ are each independently a halogen atom, a carboxyl group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₇-C₃₀ arylalkyl group, a substituted or unsubstituted C₅-C₃₀ heteroaryl group, or a substituted or unsubstituted C₃-C₃₀ heteroarylalkyl group.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the oxetane resin of Formula 1 may be a compound represented by Formula 2:

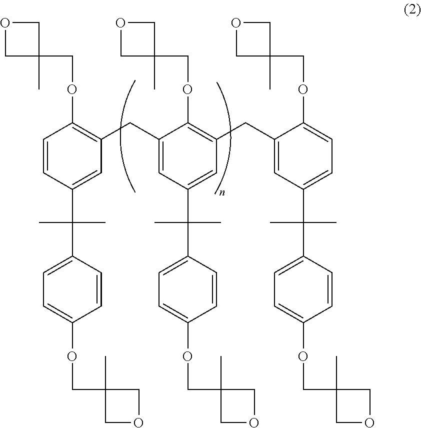

where n may be an integer from 1 to 20.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the cationic photoinitiator includes an aromatic halonium salt or an aromatic sulfonium salt.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the solvent may be α-butyrolactone, γ-butyrolactone, propylene glycol methyl ethyl acetate, tetrahydrofuran, methyl ethyl ketone, methyl isobutyl ketone, cyclopentanone, or xylene.

In another aspect, the disclosure provides an inkjet printhead including a substrate having an ink feed hole; a chamber layer disposed on the substrate, the chamber layer having a plurality of ink chambers that may be tilled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the adhesion improving agent includes a polyhydric alcoholic compound or a silane-based compound.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the adhesion improving agent includes a polyhydric alcoholic compound or a silane-based compound, and wherein the polyhydric alcoholic compound may be trimethylolethane, trimethylolpropane, 2-methylpropanetriol, glycerol, a glycerol derivative, 1,2,5-pentanetriol, 1,2,4-butanetriol, pentaerythritol, dipentaerythritol, tripentaerythritol, sorbitol, 2-hydroxymethylpropane-1,3-diol, 2-methyl-1,2,4-butanetriol, 1,3,5-trihydroxymethylbenzene, 1,2,3,6-hexanetetrol, or 1,4-sorbitan, wherein the glycerol derivative includes a compound represented by Formula 3:

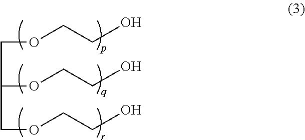

where p, q, and r are each independently an integer from 1 to 20.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the adhesion improving agent includes a polyhydric alcoholic compound or a silane-based compound, and wherein the silane-based compound includes a compound represented by Formula 4:

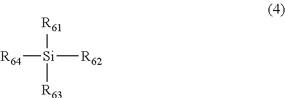

where R₆₁, R₆₂, R₆₃ and R₆₄ are each independently hydrogen, a halogen atom, a carboxyl group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₇-C₃₀ arylalkyl group, a substituted or unsubstituted C₅-C₃₀ heteroaryl group, or a substituted or unsubstituted C₃-C₃₀ heteroarylalkyl group.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the adhesion improving agent includes a polyhydric alcoholic compound or a silane-based compound, and wherein the silane-based compound may be glycidoxypropyltrimethoxysilane, glycidoxypropylmethyldimethoxysilane, glycidoxypropyldimethylethoxysilane, mercaptopropyltrimethoxysilane, γ-aminopropyltrimethoxysilane, γ-aminopropyltriethdxysilane, or N-(β-aminoethyl)-γ-aminopropyltrimethoxysilane.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, wherein the oxetane resin composition includes an oxetane resin, a cationic photoinitiator, a solvent, and an adhesion improving agent, and wherein the oxetane resin composition includes about 1 to about 20 parts by weight of a cationic photoinitiator, about 30 to about 300 parts by weight of a solvent and about 1 to about 20 parts by weight of an adhesion improving agent, based on 100 parts by weight of the oxetane resin.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, and wherein the chamber layer and the nozzle layer includes cured products of a first photosensitive polymer composition and a second photosensitive polymer composition, respectively, and each of the first photosensitive polymer composition and the second photosensitive polymer composition includes a prepolymer, a cationic photoinitiator, and a solvent.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, and wherein the chamber layer and the nozzle layer includes cured products of a first photosensitive polymer composition and a second photosensitive polymer composition, respectively, and each of the first photosensitive polymer composition and the second photosensitive polymer composition includes a prepolymer, a cationic photoinitiator, and a solvent, and wherein the prepolymer may be a glycidyl ether functional group, a ring-opened glycidyl ether functional group, or an oxetane functional group in a monomer repeating unit.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, and wherein the chamber layer and the nozzle layer includes cured products of a first photosensitive polymer composition and a second photosensitive polymer composition, respectively, and each of the first photosensitive polymer composition and the second photosensitive polymer composition includes a prepolymer, a cationic photoinitiator, and a solvent, wherein the prepolymer may be a glycidyl ether functional group, a ring-opened glycidyl ether functional group, or an oxetane functional group in a monomer repeating unit, and wherein the prepolymer has a phenol novolac resin-based backbone, a bisphenol-A-based backbone, a bisphenol-F-based backbone, or an alicyclic backbone.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, and wherein the chamber layer and the nozzle layer includes cured products of a first photosensitive polymer composition and a second photosensitive polymer composition, respectively, and each of the first photosensitive polymer composition and the second photosensitive polymer composition includes a prepolymer, a cationic photoinitiator, and a solvent, and wherein the prepolymer may be a compound of Formulae 5 through 13:

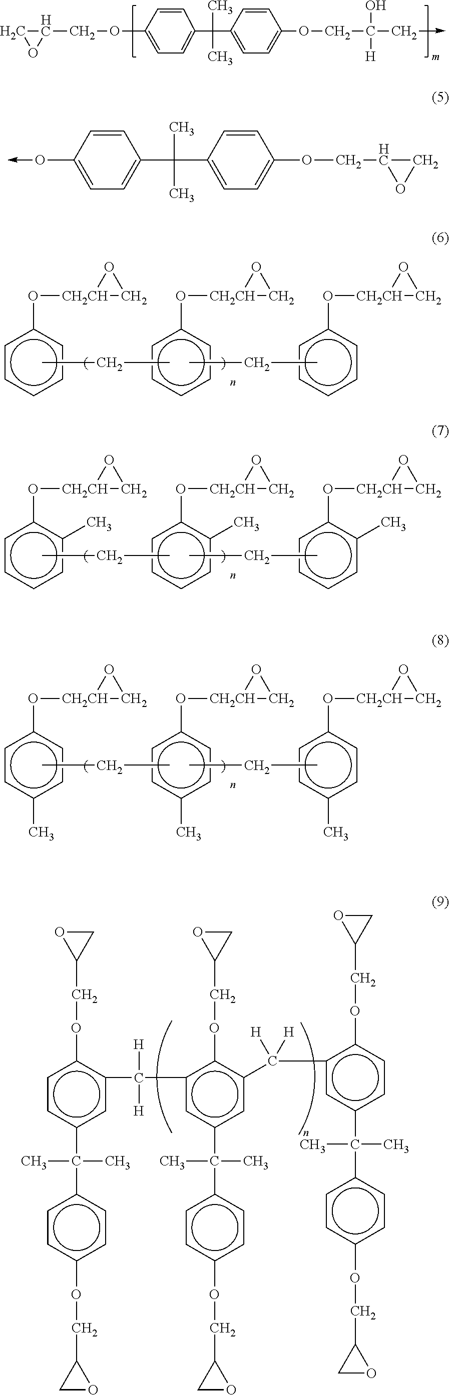

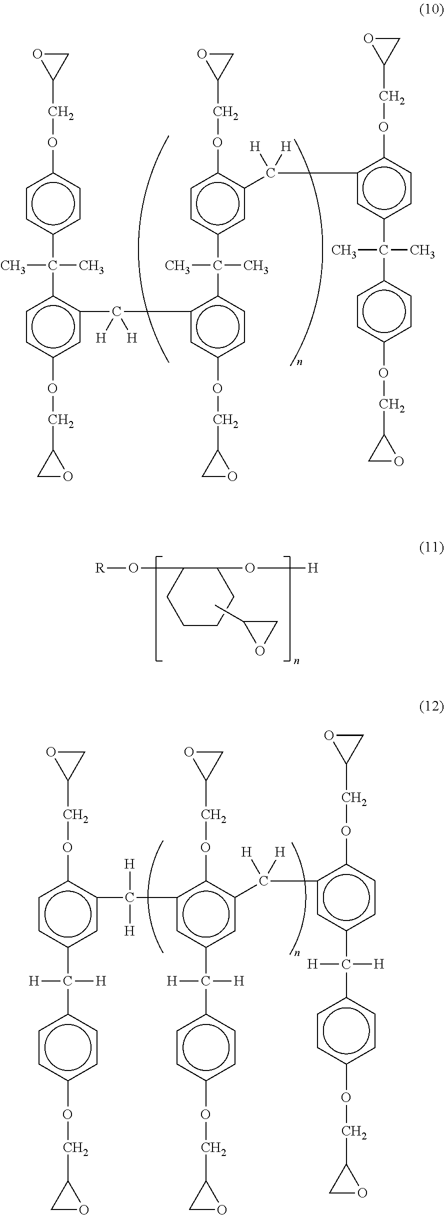

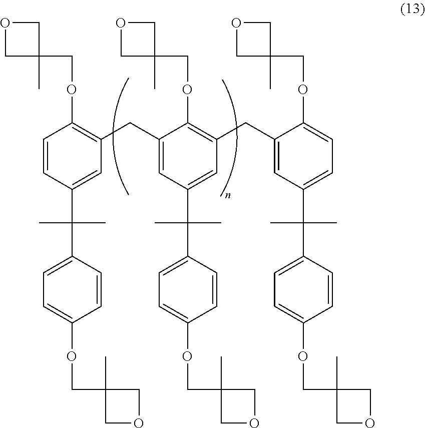

where m may be an integer from 1 to 20, and n may be an integer from 1 to 20.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, further including an insulating layer disposed on the substrate; a plurality of heaters and a plurality of electrodes sequentially disposed on the insulating layer; and a passivation layer disposed to cover the plurality of heaters and the plurality of electrodes.

In another aspect, the disclosure provides an inkjet printhead including a substrate having an ink feed hole; a chamber layer disposed on the substrate, the chamber layer having a plurality of ink chambers that may be filled with ink supplied through the ink feed hole; a nozzle layer disposed on the chamber layer, the nozzle layer having a plurality of nozzles through which ink may be ejected; and a glue layer disposed between the substrate and the chamber layer, wherein the glue layer includes a cured product of an oxetane resin composition, further including an insulating layer disposed on the substrate; a plurality of heaters and a plurality of electrodes sequentially disposed on the insulating layer; and a passivation layer disposed to cover the plurality of heaters and the plurality of electrodes, and further including an anti-cavitation layer disposed on the passivation layer.

In another aspect, the disclosure provides a method of manufacturing an inkjet printhead by forming a glue layer on a substrate; forming a chamber layer on the glue layer; forming a nozzle layer including a plurality of nozzles on the chamber layer; forming an ink feed hole from a bottom surface to a top surface of the substrate to penetrate the substrate; and forming an ink chamber and a restrictor through the ink feed hole, wherein the glue layer includes a cured product of an oxetane resin composition.

In another aspect, the disclosure provides a method of manufacturing an inkjet printhead by forming a glue layer on a substrate; forming a chamber layer on the glue layer; forming a nozzle layer including a plurality of nozzles on the chamber layer; forming an ink feed hole from a bottom surface to a top surface of the substrate to penetrate the substrate; and forming an ink chamber and a restrictor through the ink feed hole, wherein the glue layer includes a cured product of an oxetane resin composition, and wherein the oxetane resin composition includes an oxetane resin, a cationic photoinitiator, a solvent, and an adhesion improving agent.

In another aspect, the disclosure provides a method of manufacturing an inkjet printhead by forming a glue layer on a substrate; forming a chamber layer on the glue layer; forming a nozzle layer including a plurality of nozzles on the chamber layer; forming an ink feed hole from a bottom surface to a top surface of the substrate to penetrate the substrate; and forming an ink chamber and a restrictor through the ink feed hole, wherein the glue layer includes a cured product of an oxetane resin composition, and wherein the oxetane resin composition includes an oxetane resin, a cationic photoinitiator, a solvent, and an adhesion improving agent, and wherein the oxetane resin may be represented by Formula 1, wherein n, and R₁ through R₅₂ are as described herein.

In another aspect, the disclosure provides a method of manufacturing an inkjet printhead by forming a glue layer on a substrate; forming a chamber layer on the glue layer; forming a nozzle layer including a plurality of nozzles on the chamber layer; forming an ink feed hole from a bottom surface to a top surface of the substrate to penetrate the substrate; and forming an ink chamber and a restrictor through the ink feed hole, wherein the glue layer includes a cured product of an oxetane resin composition, and wherein the oxetane resin composition includes an oxetane resin, a cationic photoinitiator, a solvent, and an adhesion improving agent, and wherein the adhesion improving agent includes a polyhydric alcoholic compound or a silane-based compound.

### BRIEF DESCRIPTION OF THE DRAWINGS

Various features and advantages of the present disclosure will become more apparent by describing in detail several embodiments thereof with reference to the attached drawings, in which:

FIG. 1 is a schematic plan view of an inkjet printhead according to an embodiment of the present disclosure.

FIG. 2 is a cross-sectional view taken along a line II-II′ of FIG. 1.

FIGS. 3 through 14 are various cross-sectional views illustrative of a method of manufacturing an inkjet printhead according to an embodiment of the present disclosure.

FIG. 15 is a scanning electron microscopic (SEM) image of a pattern A formed using the glue layer forming composition obtained in Example 3;

FIG. 16 is a SEM image of a pattern B formed using the glue layer forming composition obtained in Example 4;

FIG. 17 is a SEM image of the surface of heaters of an inkjet printhead manufactured using a photosensitive glue layer forming composition according to an embodiment of the present disclosure; and

FIG. 18 is a SEM image of the surface of heaters of an inkjet printhead manufactured using a conventional non-photosensitive glue layer forming composition.

### DETAILED DESCRIPTION OF SEVERAL EMBODIMENTS

Aspects of the present disclosure will now be described more fully with reference to the accompanying drawings, in which several embodiments of the present disclosure are shown. In the drawings, like reference numerals denote like elements, and the size or the thickness of each element may be exaggerated for clarity. It will also be understood that when a layer is referred to as being on another layer or substrate, it can be directly on the other layer or substrate, or intervening layers may also be present.

### DEFINITIONS

The term alkyl group used for a substituent used in the present disclosure may refer to a linear or branched C₁-C₂₀ alkyl group, a linear or branched C₁-C₁₂ alkyl group, or a linear or branched C₁-C₆ alkyl group. Examples of the unsubstituted alkyl group include but are not limited to methyl, ethyl, n-propyl, isopropyl, n-butyl, isobutyl, sec-butyl, t-butyl, pentyl, iso-amyl, hexyl, and the like. At least one hydrogen atom in the alkyl group may be substituted with a halogen atom, a hydroxyl group, a —SH group, a nitro group, a cyano group, a substituted or unsubstituted amino group (—NH₂, —NH(R), —N(R′)(R″) wherein R′ and R″ are each independently a C₁-C₂₀ alkyl group), an amidino group, hydrazine, hydrazone, a carboxyl group, a sulfonic acid group, a phosphoric acid, a C₁-C₂₀ alkyl group, a halogenated C₁-C₂₀ alkyl group, a C₁-C₂₀ alkenyl group, a C₁-C₂₀ alkynyl group, a C₁-C₂₀ heteroalkyl group, a C₆-C₂₀ aryl group, a C₆-C₂₀ arylalkyl group, a C₆-C₂₀ heteroaryl group, or a C₆-C₂₀ heteroarylalkyl group.

The term cycloalkyl group used in the present disclosure refers to a monovalent monocyclic system of 3-20 carbon atoms, 3-10 carbon atoms, or 3-6 carbon atoms. In the cycloalkyl group, at least one hydrogen atom may be substituted with the substituents described in connection with the alkyl group.

The term heterocycloalkyl group used in the present disclosure refers to a monovalent monocyclic system of 3-20 carbon atoms, 3-10 carbon atoms, or 3-6 carbon atoms, containing one, two, or three heteroatoms selected from nitrogen (N), oxygen (O), phosphorus (P), and sulfur (S). Optionally, one or more hydrogen atoms in the heterocycloalkyl group may be substituted with any of the substituents described in connection with the alkyl group.

The term alkoxy group used for a substituent in the present disclosure may refer to an oxygen-containing linear or branched alkoxy group having a C₁-C₂₀ alkyl moiety. The alkoxy group may have 1-60 carbon atoms or 1-3 carbon atoms. Examples of such alkoxy group include but are not limited to methoxy, ethoxy, propoxy, butoxy, t-butoxy, and the like. The alkoxy group may be a haloalkoxy group substituted further with one or more halogen atoms. Examples of the haloalkoxy group include but are not limited to fluoromethoxy, chloromethoxy, trifluoromethoxy, trifluoroethoxy, fluoroethoxy, fluoropropoxy, and the like. Optionally, one or more hydrogen atoms in the alkoxy group may be substituted with the substituents described in connection with the alkyl group.

The term alkenyl group used for a substituent in the present disclosure refers to a linear or branched C₁-C₂₀ aliphatic hydrocarbon group. The alkenyl group may have 2-12 carbon atoms or 2-6 carbon atoms. The branched C₂-C₂₀ aliphatic hydrocarbon refers to a linear alkenyl chain to which at least one low alkyl or low alkenyl group may be attached. Such an alkenyl group may be unsubstituted or may be independently substituted with one or more halo, carboxy, hydroxy, formyl, sulfur, sulfino, carbamoyl, amino or imino groups. However, the substituents of the alkenyl group may not be limited to these groups. Examples of such alkenyl groups include but are not limited to ethenyl, prophenyl, carboxyethenyl, carboxyprophenyl, sulfinoethenyl, sulfonoethenyl, and the like. Optionally, one or more hydrogen atoms in the alkenyl group may be substituted with the substituents described in connection with the alkyl group.

The term alkynyl group used for a substituent in the present disclosure refers to a straight or branched C₂-C₂₀ aliphatic hydrocarbon group including a carbon-carbon triple bond. Examples of such an alkenyl group include alkenyl groups containing 2-12 carbon atoms or 2-6 carbon atoms. The branched C₂-C₂₀ aliphatic hydrocarbon group having a C—C triple bond may refer to a linear alkynyl chain to which at least one low alkyl or low alkynyl group may be attached. Such an alkenyl group may not be substituted, or may be independently substituted with one or more halo, carboxy, hydroxy, formyl, sulfur, sulfino, carbamoyl, amino or imino groups. However, the substituent of the alkenyl group may not be limited to these groups. Optionally, one or more hydrogen atoms in the alkynyl group may be substituted with the substituents described in connection with the alkyl group.

The term heteroalkyl group used for a substituent in the present disclosure refers to an alkyl group in which a linear chain of 1-20 carbons, 1-12 carbons, or 1-6 carbons includes a hetero atom, such as nitrogen (N), oxygen (O), phosphorus (P), or sulfur (S). Optionally, one or more hydrogen atoms in the heteroalkyl group may be substituted with the substituents described in connection with the alkyl group.

The term aryl group used for a substituent in the present disclosure refers to a C₆₋₃₀ carbocyclic aromatic system, which may be used exclusively or in combination, including at least one ring that may be attached to each other using a pendent method or may be fused together. The term aryl group refers to a group including but not limited to an aromatic radical, such as phenyl, naphthyl, tetrahydronaphthyl, indan, biphenyl, and the like. For example, the aryl group may include phenyl. Optionally, one or more hydrogen atoms in the aryl group may be substituted with the substituents described in connection with the alkyl group.

The term arylalkyl group used for a substituent in the present disclosure refers to an alkyl group including at least one hydrogen atom substituted with an aryl group.

The term heteroaryl group used for a substituent in the present disclosure refers to a C₅-C₃₀ monovalent monocyclic or non-cyclic aromatic radical including one, two, or three heteroatoms selected from N, O, and S. In addition, the heteroaryl group may refer to a monovalent monocyclic or bicyclic aromatic radical group in which a hetero atom in the chain of the radical group may be oxidized or quanternized to form, for example, an N-oxide or a quaternary salt. Examples of the heteroaryl group include but are not limited to thienyl, benzothienyl, pyridyl, pyrazinyl, pyrimidinyl, pyridazinyl, quinolinyl, quinoxalinyl, imidazolyl, puranyl, benzopuranyl, thiazolyl, isoxazoline, benzisoxazoline, benzimidazolyl, triazolyl, pyrazolyl, pyrrolyl, indolyl, 2-pyridonyl, N-alkyl-2-pyridonyl, pyrazinonyl, pyridazinonyl, pyrimidinonyl, oxazolonyl, an N-oxide thereof, such as pyridyl N-oxide or quinolinyl N-oxide, a quaternary salt thereof, and the like. Optionally, one or more hydrogen atoms in the heteroaryl group may be substituted with the substituents described in connection with the alkyl group.

The term heteroarylalkyl group used for a substituent in the present disclosure refers to a C₃-C₃₀ carbocyclic aromatic system in which at least one hydrogen atom in such an alkyl group as defined above may be substituted with such a heteroaryl group as defined above. Optionally, one or more hydrogen atoms in the heteroarylalkyl group may be substituted with the substituents described in connection with the alkyl group.

### Thermal Inkjet Printhead

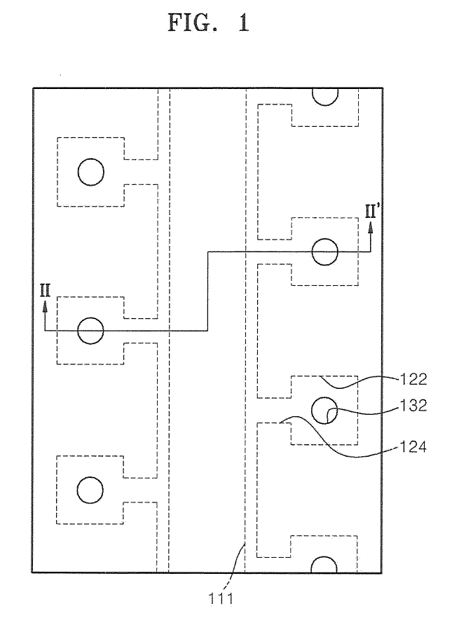

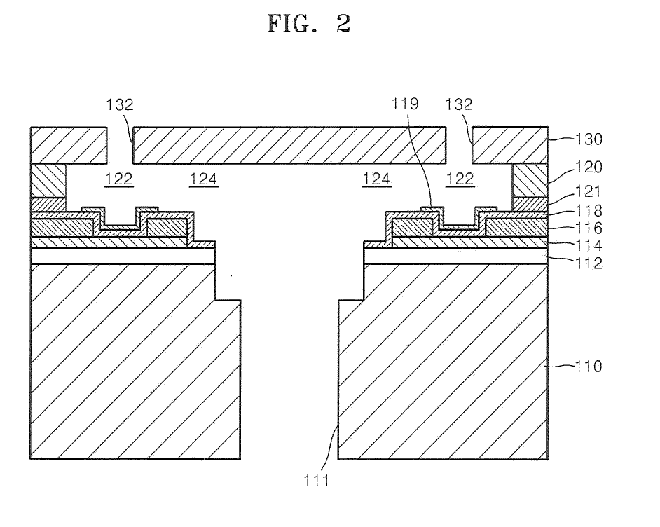

FIG. 1 provides a schematic view of a thermal inkjet printhead according to an embodiment of the present disclosure. FIG. 2 is a cross-sectional view taken along a line II-II′ of FIG. 1. Referring to FIGS. 1 and 2, a thermal inkjet printhead according to an embodiment may comprise a glue layer 121, a chamber layer 120 and a nozzle layer 130 sequentially formed on a substrate 110 on which various material layers are formed. The substrate 110 may be formed of, for example, silicon. An ink feed hole 111 for supplying ink may be formed through the substrate 110. An insulating layer 112 may be formed on the substrate 110 in order to thermally and electrically insulate from one another the substrate 110 and a heater 114, which will be described later. To that end, the insulating layer 112 may be formed of, for example, silicon oxide. The heater 114 for heating ink contained in an ink chamber 122 to generate ink bubbles may be formed on the insulating layer 112. In this regard, the heater 114 may be formed underneath the ink chamber 122. The heater 114 may be formed of a heating resistor material including, but not limited to, a tantalum-aluminum alloy, a tantalum nitride, a titanium nitride, or a tungsten silicide, and the like. An electrode 116 may be formed on the top surface of the heater 114. The electrode 116 may be formed of a material having good to excellent electrical conductivity in order to supply current to the heater 114. The electrode 116 may be formed of conducting metals including, but not limited to, aluminum (Al), an aluminum alloy, gold (Au), silver (Ag), and the like. A passivation layer 118 may be formed on the heater 114 and the electrode 116. In this regard, the passivation layer 118 may be formed in order to prevent oxidization and corrosion of the heater 114 and the electrode 116 caused by the ink. The passivation layer 118 may be formed of a silicon nitride or a silicon oxide. An anti-cavitation layer 119 may further be formed on a surface region of the passivation layer 118 corresponding to the heater 114. In this regard, the anti-cavitation layer 119 may be formed in order to protect the heater 114 from a cavitation force generated when bubbles are burst. The anti-cavitation layer 119 may be formed of for example, tantalum (Ta).

The glue layer 121 stably binds the chamber layer 120 to the substrate 110. Alternatively, the glue layer 121 stably binds the chamber layer 120 to the passivation layer 118 when the substrate 110 includes the insulating layer 112, the heater 114, the electrode 116, and the passivation layer 118 sequentially formed thereon. The glue layer 121 may include a cured product of an oxetane resin composition. For example, the glue layer 121 may be formed by coating the substrate 110 with an oxetane resin composition, and by patterning the resultant coated composition into a predetermined pattern by using a photolithography process. The oxetane resin composition may include an oxetane resin, a cationic photoinitiator, a solvent and an adhesion improving agent. The oxetane resin may be represented by Formula (1) below:

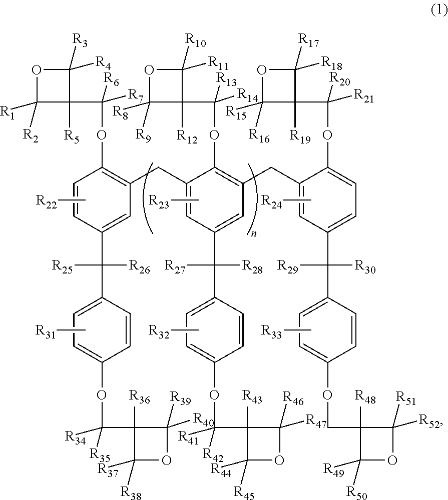

where n may be an integer from 1 to 20, and where R₁ through R₅₂ are each independently a halogen atom, a carboxyl group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₇-C₃₀ arylalkyl group, a substituted or unsubstituted C₅-C₃₀ heteroaryl group, or a substituted or unsubstituted C₃-C₃₀ heteroarylalkyl group.

The oxetane resin of Formula (1) may be a compound represented by Formula 2:

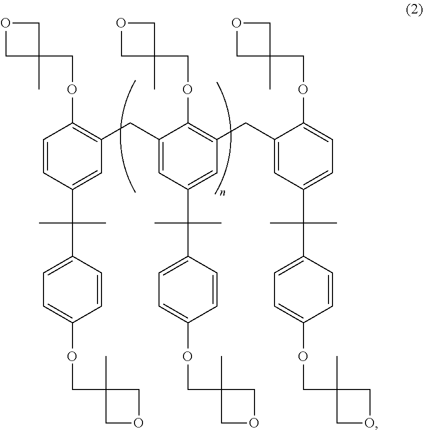

where n may be an integer from 1 to 6.

The oxetane resin may exhibit excellent photo-curable characteristics. When an oxetane resin composition containing the oxetane resin is used, the glue layer 121 may be formed in an appropriate location. The oxetane resin coated in regions other than the glue layer region and not exposed to light irradiation, may be completely removed through a developing process so that oxetane resin remaining in the inkjet printhead does not cause any failures of the printhead.

The cationic photoinitiator in the oxetane resin composition may generate an ion or a free radical that initiates polymerization when exposed to light. Examples of such a cationic photoinitiator include, but are not limited to, an aromatic halonium salt and a sulfonium salt of Group VA and VI elements, and the like. For example, the cationic photoinitiator may be UVI-6974 (available from Union Carbide Co.) or SP-172 (available from Asahi Denka Co., Ltd). Examples of the aromatic sulfonium salt include but are not limited to triphenylsulfonium tetrafluoroborate, triphenylsulfonium hexafluoroantimonate (UVI-6974), phenylmethylbenzylsulfonium hexafluoroantimonate, phenylmethylbenzylsulfonium hexafluorophosphate, triphenylsulfonium hexafluorophosphate, methyl diphenylsulfonium tetrafluoroborate, and dimethyl phenylsulfonium hexafluorophosphate, and the like. Examples of the aromatic halonium salt include but are not limited to an aromatic iodonium salt. Examples of the aromatic iodonium salt include but are not limited to diphenyliodonium tetrafluoroborate, diphenyliodonium hexafluoroantimonate, butylphenyliodonium hexafluoroantimonate, (SP-172), and the like.

In one embodiment, the amount of the cationic photoinitiator may be in the range of about 1 to about 20 parts by weight, based on 100 parts by weight of the oxetane resin. In another embodiment, the amount of the cationic photoinitiator may be in the range of about 1.5 to about 15 parts by weight, based on 100 parts by weight of the oxetane resin. In yet another embodiment, the amount of the cationic photoinitiator may be in the range of about 3 to about 10 parts by weight, based on 100 parts by weight of the oxetane resin. When the amount of the cationic photoinitiator is within these ranges, sufficient crosslinking reaction may take place, and photoenergy may not be excessively consumed to form a glue layer having an appropriate thickness so that the crosslinking rate may be increased.

The solvent may include, but are not limited to, α-butyrolactone, γ-butyrolactone, propylene glycol methyl ethyl acetate, tetrahydrofuran, methyl ethyl ketone, methyl isobutyl ketone, cyclopentanone, xylene, and the like. In one embodiment, the amount of the solvent may be in the range of about 30 to about 300 parts by weight, based on 100 parts by weight of the oxetane resin. In another embodiment, the amount of the solvent may be in the range of about 50 to about 250 parts by weight, based on 100 parts by weight of the oxetane resin. In yet another embodiment, the amount of the solvent may be in the range of about 70 to about 200 parts by weight, based on 100 parts by weight of the oxetane resin. When the amount of the solvent is within these ranges, the oxetane resin composition may have an appropriate viscosity, and thus have improved workability. As a result, a glue layer pattern may be easily formed.

The adhesion improving agent may be any material that intensifies the adhesion of the oxetane resin in the oxetane resin composition to the substrate 110, which may be formed of an inorganic material, the passivation layer 118, or to the chamber layer 120, which may be formed of an organic material. Examples of the adhesion improving agent may include, but are not limited to, polyhydric alcoholic compounds, silane-based compounds, and the like. Polyhydric alcoholic compounds have several hydrophilic hydroxyl groups and hydrophobic aliphatic groups, and thus can effectively bind to both the substrate 110, which has hydrophilic surface characteristics, and the chamber layer 120, which may be formed of a hydrophobic organic material. In addition, silane-based compounds include side chains that are liable to be separated from a core element, silicon (Si), and thus, may form a strong bond with the substrate 110 and the chamber layer 120. The silane-based compounds may provide excellent characteristics for the glue layer 121.

Polyhydric alcoholic compounds include but are not limited to trimethyl-olethane, trimethylolpropane, 2-methylpropanetriol, glycerol, a glycerol derivative, 1,2,5-pentanetriol, 1,2,4-butanetriol, pentaerythritol, dipentaerythritol, tripentaerythritol, sorbitol, 2-hydroxymethylpropane-1,3-diol, 2-methyl-1,2,4-butanetriol, 1,3,5-trihydroxymethylbenzene, 1,2,3,6-hexanetetrol, 1,4-sorbitan, and the like. A glycol derivative may be a compound represented by Formula (3) below:

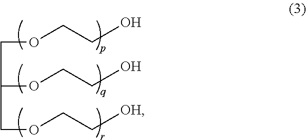

where p, q, and r are each independently an integer from 1 to 20.

The silane-based compound may include, but is not limited to, glycidoxypropyl-trimethoxysilane, glycidoxypropylmethyldimethoxysilane, glycidoxypropyldimethyl-ethoxysilane, mercaptopropyltrimethoxysilane, γ-aminopropyltrimethoxysilane, γ-aminopropyltriethoxysilane, N-(β-aminoethyl)-γ-aminopropyltrimethoxysilane, and the like. An example of such a silane-based compound may include a compound represented by Formula (4) below:

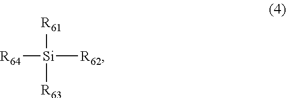

where R₆₁, R₆₂, R₆₃ and R₆₄ are each independently hydrogen, a halogen atom, a carboxyl group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted heteroalkyl group, a substituted or unsubstituted C₆-C₃₀ aryl group, a substituted or unsubstituted C₇-C₃₀ arylalkyl group, a substituted or unsubstituted C₅-C₃₀ heteroaryl group, or a substituted or unsubstituted C₃-C₃₀ heteroarylalkyl group.

In one embodiment, the amount of the adhesion improving agent may be in the range of about 1 to 20 parts by weight, based on 100 parts by weight of the oxetane resin. In another embodiment, the amount of the adhesion improving agent may be in the range of about 1.5 to about 15 parts by weight, based on 100 parts by weight of the oxetane resin. In yet another embodiment, the amount of the adhesion improving agent may be in the range of about 3 to about 10 parts by weight, based on 100 parts by weight of the oxetane resin. When the amount of the adhesion improving agent is within these ranges, the glue layer 121 may have enhanced adhesiveness without any effect on the photocuring reaction in the oxetane resin.

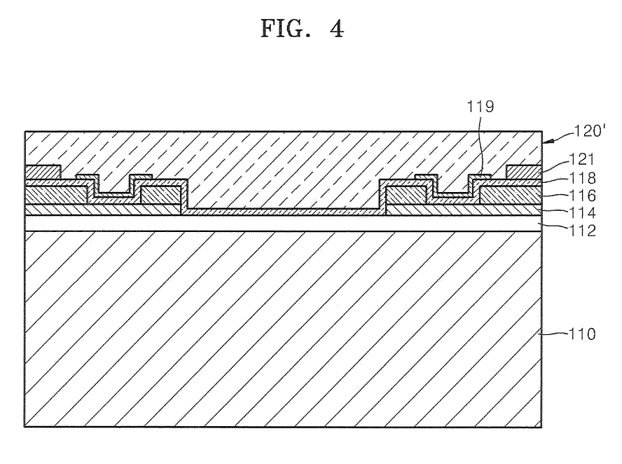

The chamber layer 120, which may be formed of a first photosensitive polymer composition, may be disposed on the glue layer 121. The chamber layer 120 has a plurality of ink chambers 122 that may be filled with ink supplied through the ink feed hole 111. The chamber layer 120 may further include a plurality of restrictors 124, which are paths connecting the ink feed hole 111 and the ink chambers 122. The chamber layer 120 may be formed by forming a chamber material layer (120′ of FIG. 4), which includes the first photosensitive polymer composition, on the glue layer 121, and by patterning the chamber material layer 120′ by using a photolithography process.

The first photosensitive polymer composition may include a negative-type photosensitive polymer. In this regard, a plurality of ink chambers 122 and restrictors 124 may be formed as unexposed regions of the first photosensitive polymer composition, which may be removed by a developing solution that will be described later. Exposed regions of the first photosensitive polymer composition form the chamber layer 120 having a cross-linked structure through a post-exposure bake (PEB) process.

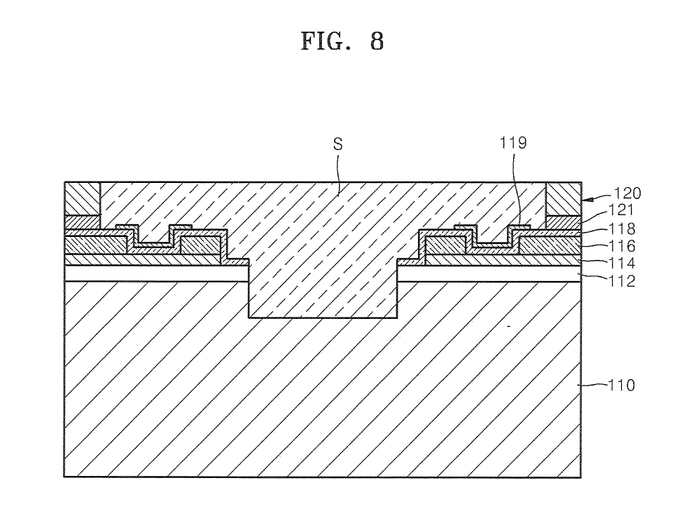

A nozzle layer 130, which may be formed of a second photosensitive polymer composition, may be formed above the chamber layer 120. The nozzle layer 130 may have a plurality of nozzles 132 through which ink may be ejected. The nozzle layer 130 may be formed by forming a nozzle material layer 130′ (see FIG. 8) including the second photosensitive polymer composition on the chamber layer 120, and by patterning the nozzle material layer 130′ by using a photolithography process.

The second photosensitive polymer composition may include a negative-type photosensitive polymer. In this regard, a plurality of nozzles 132 may be formed as unexposed regions of the second photosensitive polymer composition, which are removed by a developing solution that will be described layer. Exposed regions of the second photosensitive polymer composition may form the nozzle layer 130 having a cross-linked structure through a FEB process. The chamber layer 120 and the nozzle layer 13 may alternatively be formed of photosensitive dry films, instead of the first and second photosensitive polymer compositions. The photosensitive dry films may be the same as the first and second photosensitive polymer compositions in terms of composition and curing method, except that the photosensitive dry films are obtained by previously removing a solvent from the first and second photosensitive polymer compositions. When such photosensitive dry films containing no flowable solvent are used, the ink feed hole 111 may be formed before the formation of the chamber layer 120 and the nozzle layer 130 since the solvent does not run. The formation of the chamber layer 120 and the nozzle layer 130 will be described later in more detail with reference to a method of manufacturing an inkjet printhead.

Each of the first and second negative photosensitive compositions used in the manufacturing methods described above may include a prepolymer, a cationic photoinitiator, and a solvent. The prepolymer may contain a glycidyl ether functional group, a ring-opened glycidyl ether functional group, or an oxetane functional group in each monomer repeat unit, including, but not limited to, a phenol Novolac resin-based backbone, a bisphenol-A-based backbone, a bisphenol-F-based backbone, an alicyclic backbone, and the like. However, the composition of the first and second photosensitive polymer compositions is not limited to the above, and any material for improving the characteristics of the first and second photosensitive polymer compositions may be further added. The first and second photosensitive polymer compositions may have the same composition or different compositions with respect to each other.

Epoxy-based materials may also be used for the prepolymer, but the present disclosure is not limited thereto. Any material suitable for forming a chamber layer or a nozzle layer of inkjet printheads may be used. For example, a prepolymer may include either a glycidyl ether functional group, a ring-opened glycidyl ether functional group, or an oxetane functional group in a monomer repeating unit, and having either a phenol novolac resin-based backbone, a bisphenol-A-based backbone, a bisphenol-F-based backbone, or an alicyclic backbone may be used.

The prepolymer in the first and second photosensitive photoresist compositions may form a crosslinked polymer by being exposed to actinic radiation. The prepolymer may include a backbone monomer including but not limited to phenol, o-cresol, p-cresol, bisphenol-A, an alicyclic compound, and the like, or a mixture thereof. Examples of prepolymers having a glycidyl ether functional group include but are not limited to a prepolymer including a bi-functional glycidyl ether group and a prepolymer including a multifunctional glycidyl ether group, and the like.

In particular, a prepolymer including a bi-functional glycidyl ether functional group may be a compound represented by Formula (5):

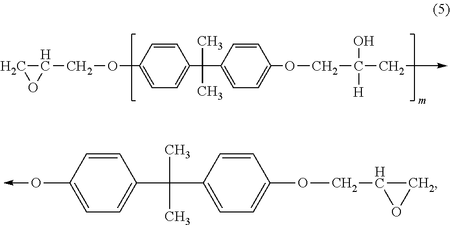

where m may be an integer from 1 to 20.

The prepolymer including the bi-functional glycidyl ether functional group may form a film having a relatively low degree of crosslinking. Examples of such a prepolymer having a bi-functional glycidyl ether functional group may include, but are not limited to, EPON 828, EPON 1004, EPON 1001F, and EPON 1010, which are available from Shell Chemical Company, DER-332, DER-331, and DER-164, which are available from Dow Chemical Company, and ERL-4201 and ERL-4289, which are available from Union Carbide Corporation, and the like. In addition, examples of prepolymers including a multi-functional glycidyl ether functional group may include, but are not limited to, EPON SU-8 and EPON DPS-16, which are available from Shell Chemical Company, DEN-431 and DEN-439, which are available from Dow Chemical Company, and EHPE-3150, which is available from Daicel Chemical Industries. Ltd., and the like.

Examples of prepolymers having a glycidyl ether functional group in a monomer repeating unit and a phenol novolac resin-based backbone may include, but are not limited to, a compound represented by Formula (6) below:

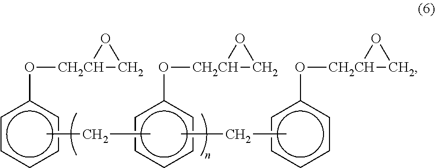

where n may be an integer from 1 to 20, for example, from 1 to 10.

Examples of prepolymers having a glycidyl ether functional group in a monomer repeating unit and a phenol novolac resin-based backbone may also include, but are not limited to, compounds including o-cresol or p-cresol, instead of phenol, as represented by Formulae (7) and (8) below:

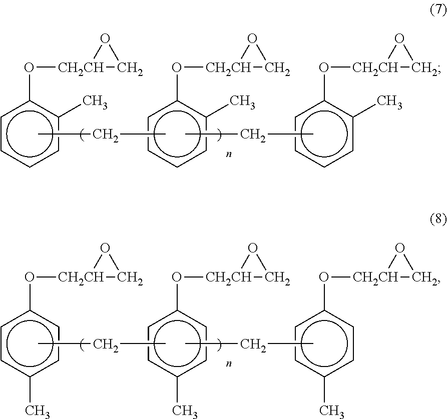

where n may be an integer from 1 to 20, for example, from 1 to 10.

Examples of prepolymers having a glycidyl ether functional group in a monomer repeating unit and a bisphenol-A-based backbone may include, but are not limited to, compounds represented by Formulae (9) and (10) below:

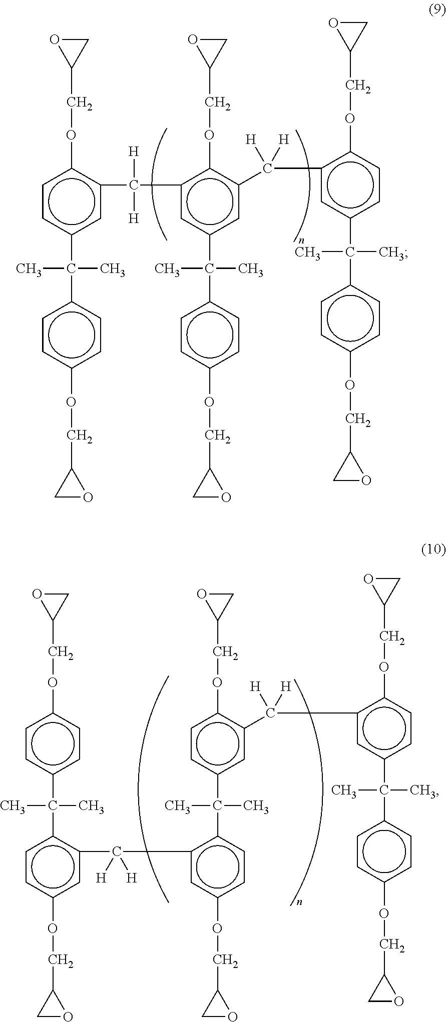

where n may be an integer from 1 to 20, for example, from 1 to 10.

Examples of prepolymers having a glycidyl ether functional group in a monomer repeating unit and an alicyclic backbone include but are not limited to a compound represented by Formula (11) below, and in particular, additional products of 1,2-epoxy-4(2-oxiranyl)-cyclohexane of 2,2-bis(hydroxy methyl)-1-butanol, which can be purchased as EHPH-3150.

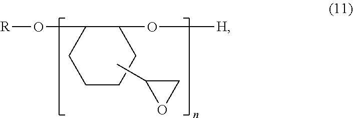

where n may be an integer from 1 to 20, for example, from 1 to 10.

Examples of prepolymers having a glycidyl ether functional group in a monomer repeating unit and a bisphenol-F-based backbone may include, but are not limited to, a compound represented by Formula (12) below:

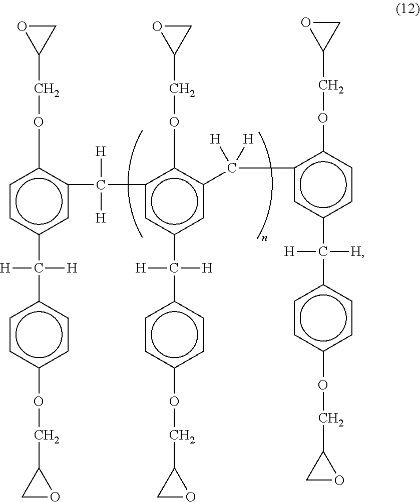

where n may be an integer from 1 to 20, for example, from 1 to 10.

Examples of prepolymers having an oxetane functional group in a monomer repeating unit and a bisphenol-A-based backbone may include, but are not limited to, a compound represented by Formula (13) below:

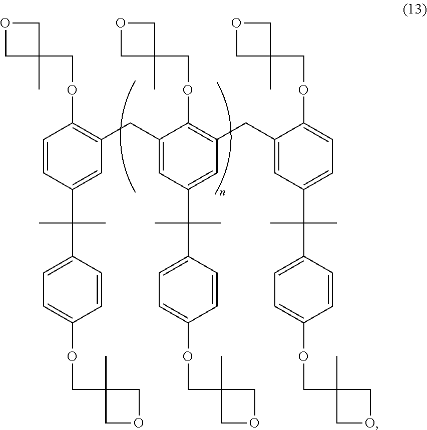

where n may be an integer from 1 to 20, for example, from 1 to 10.

As described above, the prepolymer included in the first and second photosensitive polymer compositions may include, but are not limited to, the compounds represented by Formulae (5) through (13) above.

The cationic photoinitiator in the first and second photosensitive polymer compositions may generate an ion or a free radical that initiates polymerization when exposed to light. Examples of the cationic photoinitiator may include, but are not limited to, an aromatic halonium salt or a sulfonium salt of Group VA or VI elements, such as UVI-6974 available from Union Carbide Co., SP-172 available from Asahi denka, and Cyracure 6974 available from Dow Chemical, and the like.

In one embodiment, the amount of the cationic photoinitiator may be in the range of about 1 to about 10 parts by weight, based on 100 parts by weight of the prepolymer. In another embodiment, the amount of the cationic photoinitiator may be in the range of about 1.5 to about 7 parts by weight, based on 100 parts by weight of the prepolymer. In yet another embodiment, the amount of the cationic photoinitiator may be in the range of about 3 to about 5 parts by weight, based on 100 parts by weight of the prepolymer. When the amount of the cationic photoinitiator is within these ranges, sufficient crosslinking reaction may take place using an appropriate amount of photoenergy, and the crosslinking rate may be increased so that the overall processing time may be reduced. The resulting photocured product may have excellent mechanical characteristics.

All the above-description of the cationic photoinitiator used in the oxetane resin composition may be applied to the cationic photoinitiator used in the first and second photosensitive polymer compositions.

Examples of the solvent used in the first and second photosensitive polymer compositions may include, but are not limited to, α-butyrolactone, γ-butyrolactone, propylene glycol methyl ethyl acetate, tetrahydrofuran, methyl ethyl ketone, methyl isobutyl ketone, cyclopentanone, xylene, and the like, or mixtures thereof.

In one embodiment, the amount of the solvent may be in the range of about 30 to about 300 parts by weight, based on 100 parts by weight of the prepolymer. In another embodiment, the amount of the solvent may be in the range of about 50 to about 250 parts by weight or about 70 to about 200 parts by weight, based on 100 parts by weight of the prepolymer. When the amount of the solvent is within these ranges, the first and second photosensitive polymer compositions may have an appropriate viscosity, and thus have improved workability. As a result, patterns of the chamber layer and the nozzle layer may be easily formed. In addition, it may be also easy to control the shape and size of ink flow paths to be more uniform.

Each of the first and second photosensitive polymer compositions may further include one or more plasticizers. In this regard, the plasticizer may prevent or substantially reduce cracks from being generated in the nozzle layer after nozzles are developed in the nozzle layer and a sacrificial layer may be eliminated to form the nozzles. In addition, the plasticizer may also reduce variations of nozzle chamber angles, and thus reduce image defects caused due to Y spacing, since the plasticizer having a high melting point functions as a lubricant among the crosslinked polymers to reduce stress in the nozzle layer. The plasticizer may simplify the entire process of manufacturing the inkjet printhead, since an additional baking process may not be required.

The plasticizer may include, but is not limited to, a phthalate-based compound, a trimellitate-based compound, a phosphate-based compound, and the like. Examples of the phthalate-based plasticizer may include, but are not limited to, dioctyl phthalate (DOP) and diglycidyl hexahydro phthalate (DGHP), and the like. An example of the trimellitate-based plasticizer may include, but is not limited to, triethylhexyl trimellitate. An example of the phosphate-based plasticizer may include, but is not limited to, tricresyl phosphate. The plasticizer may be used exclusively or included in a combination of at least two of the above listed compounds. In one embodiment, the amount of the plasticizer may be in the range of about 1 to 15 parts by weight, based on 100 parts by weight of the prepolymer. In another embodiment the amount of the plasticizer may be in the range of about 5 to about 10 parts by weight, based on 100 parts by weight of the prepolymer. When the amount of the plasticizer is within these ranges, the plasticizer may effectively work without affecting the degree of crosslinking of the prepolymer.

Each of the first and second photosensitive polymer compositions may further include one or more additives including, but not limited to, a photosensitizer silane coupling agent, a filler, a viscosity modifier, and the like. The photosensitizer absorbs light energy and facilitates transfer of the energy to another compound to generate a radical or ionic initiator. Mostly, the photosensitizer widens an energy wavelength range effective for light exposure. The photosensitizer may be typically an aromatic light-absorbing chromophore. In addition, the photosensitizer may induce generation of a radical or ionic photoinitiator. Each of the first and second photosensitive polymer compositions may further include an additive other than the above-listed additives.

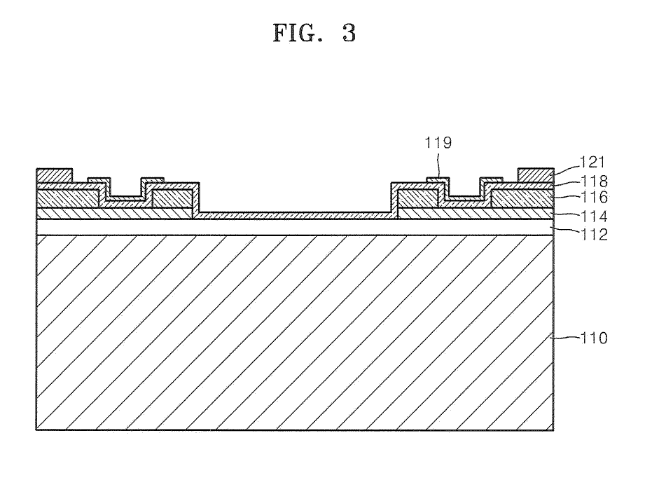

FIGS. 3 through 12 are cross-sectional views of an inkjet printhead according to an embodiment of the present disclosure illustrative of the method according to an embodiment of manufacturing the inkjet printhead. Referring to FIG. 3, a substrate 110 may be prepared, and an insulating layer 112 may be formed on a surface of the substrate 110. The substrate 110 may be a silicon substrate. The insulating layer 112, which insulates from one another the substrate 110 and heaters 114, which will be described later, may be formed of, for example, silicon oxide. The heaters 114 for heating ink to generate ink bubbles are formed on the insulating layer 112. The heaters 114 may be formed by depositing a heating resistive material, such as a tantalum-aluminum alloy, a tantalum nitride, a titanium nitride, or a tungsten silicide, on the insulating layer 112, and by patterning the heating resistive material. A plurality of electrodes 116 for supplying current to the heaters 114 are formed on the heaters 114. The electrodes 116 may be formed by depositing a metal having excellent electrical conductivity, such as aluminum (Al), an Al alloy, gold (Au), or silver (Ag), on the heaters 114, and then patterning the metal. A passivation layer 118 may be formed on the insulating layer 112 so as to cover the heaters 114 and the electrodes 116. The passivation layer 118 prevents the heaters 114 and the electrodes 116 from being oxidized or corroded by ink contacting the same. The passivation layer 118 may be formed of a silicon nitride or a silicon oxide. A glue layer 121 as described above may be formed on the passivation layer 118 in order to increase an adhesion force between a chamber material layer 120′ and the passivation layer 118. An anti-cavitation layer 119 may further be formed on a surface region of the passivation layer 118 corresponding to the heaters 114. The anti-cavitation layer 119 protects the heaters 114 from a cavitation force generated when bubbles are burst. The anti-cavitation layer 119 may be formed of tantalum (Ta).

Referring to FIG. 4, the chamber material layer 120′ may be formed on the passivation layer 118. The chamber material layer 120′ may include a first photoresist polymer composition. The chamber material layer 120′ may be formed by laminating a dry film including a photosensitive resin, a photo acid generator (PAG), a cationic photoinitiator, or the like, on the passivation layer 118. The photosensitive resin in the chamber material layer 120′ may be a negative-type photosensitive polymer, for example, a prepolymer included in the first photosensitive polymer composition described above. The chamber material layer 120′ may be subjected to a light exposure process and a PEB process. In particular, the chamber material layer 120′ may be s exposed to light by using a photomask (not shown) having an ink chamber pattern and a restrictor pattern. In this regard, when the chamber material layer 120′ includes the first photosensitive polymer composition, ions or free radicals that initiate polymerization are generated in exposed regions 120′a of the chamber material layer 120′ by the cationic photoinitiator as a result of the exposure process. Alternatively, when the chamber material layer 120′ includes a negative-type photosensitive polymer, acid may be generated in the exposed regions 120′a of the chamber material layer 120′ by, for example, a photoacid generator (PAG), as a result of the exposure process. The exposed chamber material layer 120′ may be subjected to the PEB process. The PEB process may be performed, for example, at a temperature ranging from about 90 to about 120° C. for about 3 to 5 minutes. In the PEB process, a cross-linking reaction occurs in the exposed regions 120′a of the chamber material layer 120′ so that a cross-linked product of the first photosensitive polymer composition may be formed.

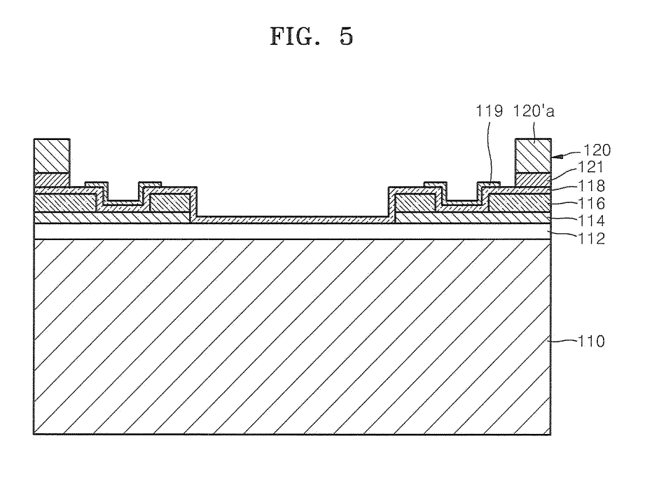

Referring to FIG. 5, the chamber material layer 120′ which has undergone the light exposure process and the PEB process may be subjected to a development process in order to form a chamber layer 120. Unexposed regions (not shown) of the chamber material layer 120′ are removed by a developing solution during the development process. In this regard, since the first photosensitive polymer composition in the exposed regions 120′a of the chamber material layer 120′ has a cross-linked structure formed through the PEB process, the exposed regions 120′a of the chamber material layer 120′ are not removed by the development process and form the chamber layer 120.

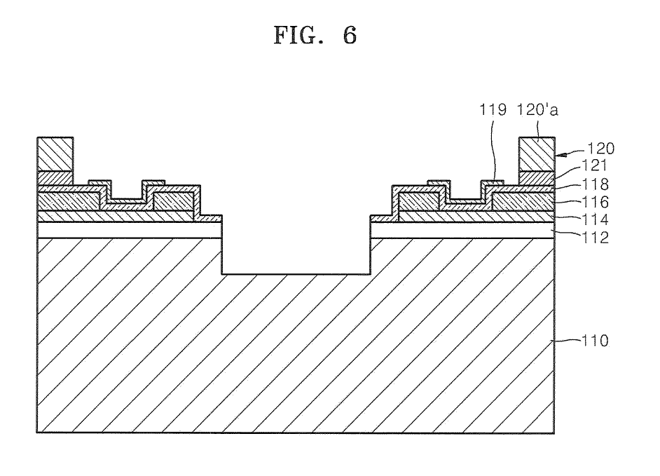

Referring to FIG. 6, after the chamber layer 120 may be formed and before a nozzle layer may be formed, the passivation layer 118, the insulating layer 112 and the substrate 110 are partially etched. This partial etching process may be effective to define the location of an ink feed hole to be formed later to pass through the substrate 110.

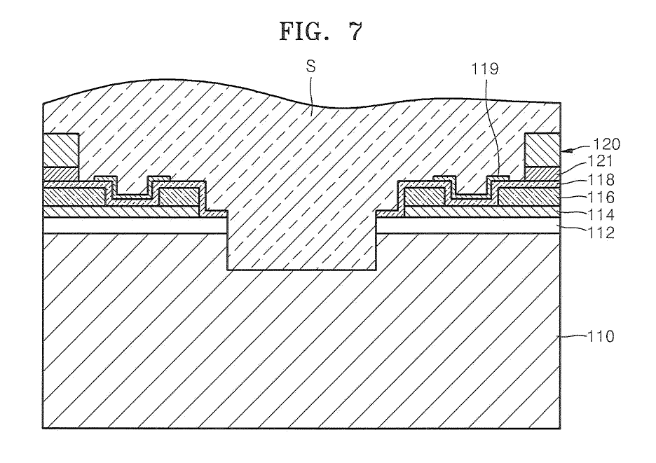

Referring to FIG. 7, a sacrificial layer S may be formed on the chamber layer 120 which has undergone the light exposure process and the PEB process. The sacrificial layer S may be formed to cover the chamber layer 120. The sacrificial layer S may be formed by coating a positive photoresist polymer or a non-photosensitive soluble polymer on the substrate 110 to a predetermined thickness by using a spin coating process, for example. In this regard, the positive photoresist polymer may be an imide-based positive photoresist polymer. When the sacrificial layer S is formed of an imide-based positive photoresist polymer, the effect of a solvent on the sacrificial layer S may be insignificant and the sacrificial layer S may not generate nitrogen gas when exposed to light. To this end, the imide-based positive photoresist polymer should be hard-baked at about 140° C. Alternatively, the sacrificial layer S may be formed by spin coating a liquid photosensitive soluble polymer on the substrate 110 to a predetermined thickness, and then by baking the resultant structure. In this regard, the liquid non-sensitized soluble polymer may include, but are not limited to, a phenol resin, a polyurethane resin, an epoxy resin, a polyimide resin, an acryl resin, a polyamide resin, an urea resin, a melamine resin, a silicon resin, and the like.

As illustrated in FIG. 8, the top surfaces of the chamber layer 120 and the sacrificial layer S may be planarized by using a chemical mechanical polishing (CMP) process. In particular, the top surfaces of the sacrificial layer S and the chamber layer 120 may be polished using CMP to a desired height of the ink passage, so that the top surfaces of the chamber layer 120 and the sacrificial layer S have the same level.

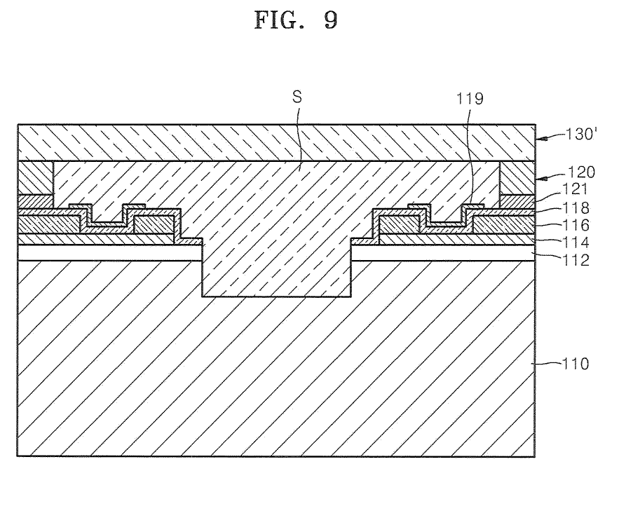

Referring to FIG. 9, a nozzle material layer 130′ may be formed on the chamber layer 120 and the sacrificial layer S. The nozzle material layer 130′ may include a second photosensitive polymer composition or the like. The nozzle material layer 130′ may be formed by laminating a dry film including a photosensitive resin, a photoacid generator (PAG), or the like, on the chamber layer 120. The photosensitive region in the nozzle material layer 130′ may be a negative-type photosensitive polymer.

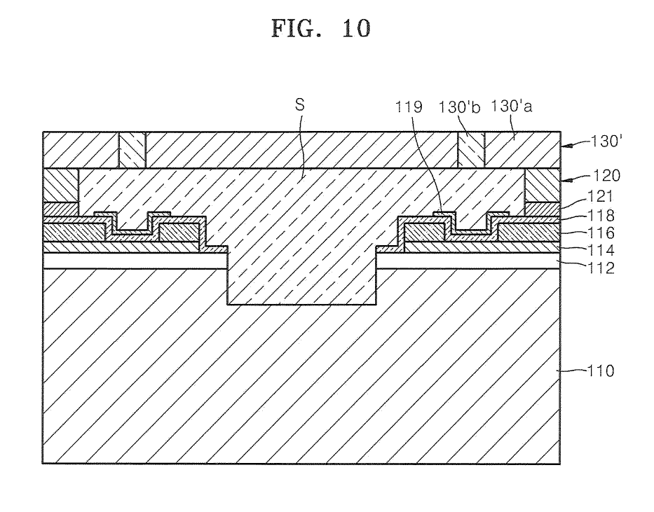

A process of forming a nozzle layer and the nozzles will now be described with reference to FIGS. 10 and 11. Initially, the nozzle material layer 130′ may be subjected to an exposure process. In particular, the nozzle material layer 130′ may be exposed to light by using a photomask (not shown) having the nozzle pattern. In this regard, when the nozzle material layer 130′ includes the second photosensitive polymer composition, ions or free radicals that initiate polymerization are generated in exposed regions 130′a of the nozzle material layer 130′ by the cationic photoinitiator as a result of the exposure process. Alternatively, when the nozzle material layer 130′ includes a negative-type photosensitive polymer, acid may be generated in the exposed regions 130′a of the nozzle material layer 130′ by, for example, a photoacid generator (PAG), as a result of the exposure process. In FIG. 10, reference numeral 130′ b indicates unexposed regions of the nozzle material layer 130′.

Referring to FIG. 11, the nozzle material layer 130′ which has undergone the exposure process may be subjected to a PEB process and a development process to form a nozzle layer 130. In particular, the nozzle material layer 130′ may be subjected to a PEB process. The PEB process may be performed, for example, a temperature ranging from about 90 to about 120° C. for about 3 to 5 minutes, but the present disclosure is not limited to these ranges. The second photosensitive polymer composition may be cross-linked in the exposed regions 130′a of the nozzle material layer 130′ due to the PEB process. The nozzle material layer 130′ may be subjected to a development process. The unexposed regions 130′ b of the nozzle material layer 130′ are removed by a predetermined developing solution through the development process, and thus a plurality of nozzles 132 are formed. In this regard, since the second photosensitive polymer composition in the exposed regions 130′a of the nozzle material layer 130′ has a cross-linked structure through the PEB process, the exposed regions 130′a of the nozzle material layer 130′ are not removed by the development process, and thus form the nozzle layer 130.

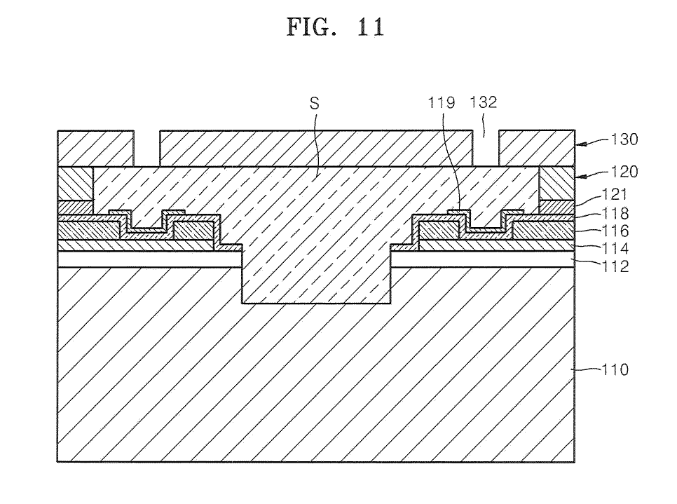

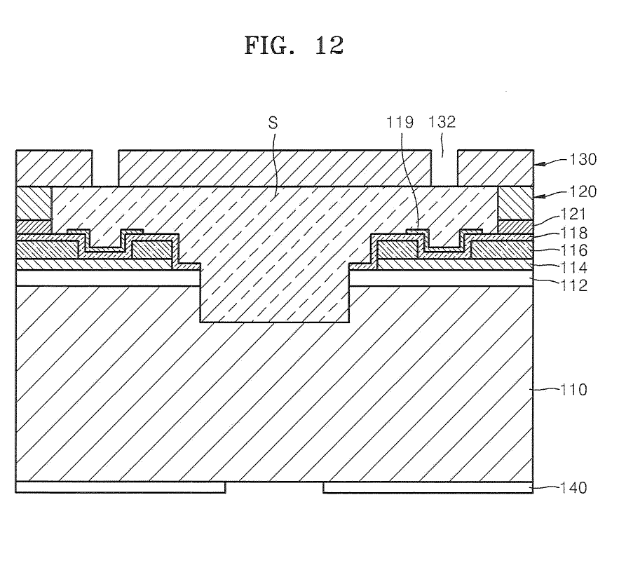

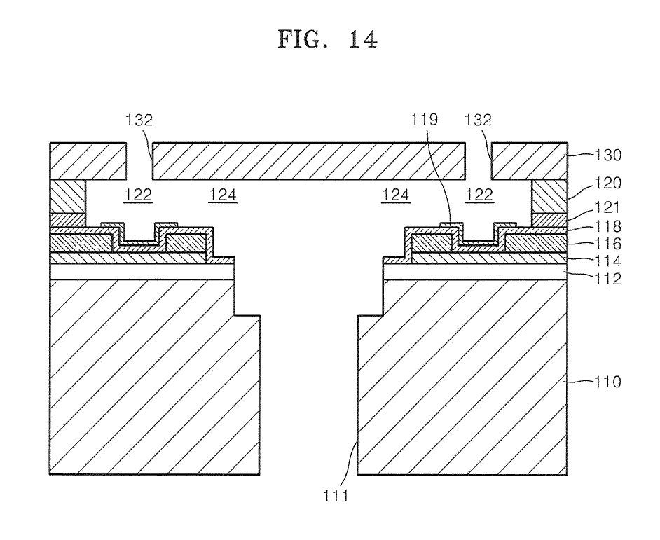

A process of forming an ink feed hole will be described with reference to FIGS. 12 through 14. Referring to FIG. 12, an etch mask 140 for forming an ink feed hole 111 (see FIG. 14) may be provided on the bottom surface of the substrate 110. The etching mask 140 may be formed, for example, by coating a positive or negative photoresist on the bottom surface of the substrate 110 and then patterning the coated photoresist.

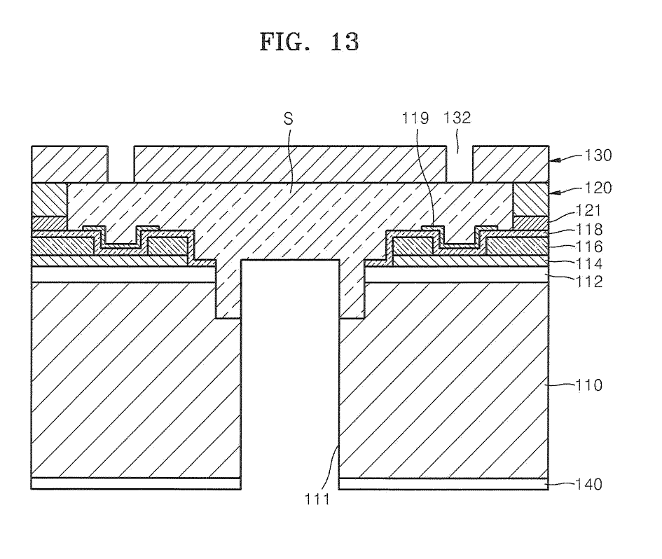

As illustrated in FIG. 13, the ink feed hole 111 may be formed by etching a bottom surface region of the substrate 110 exposed by the etching mask 140 to penetrate the substrate 110. The etching mask 140 may then be removed as illustrated in FIG. 14. The bottom surface of the substrate 110 may be etched using a dry etching method, for example, using plasma. Alternatively, the bottom surface of the substrate 110 may be etched using a wet etching method, for example, by using tetra-methyl ammonium hydroxide (TMAH) or potassium hydroxide (KOH) as an etchant. Alternatively, the ink feed hole 111 may be formed by laser processing or various other processes. Finally, the sacrificial layer S may be removed by using a solvent to form an ink chamber 122 and a restrictor 124, which are surrounded by the chamber layer 120. Through the above-described process, an inkjet printhead according to an embodiment as illustrated in FIG. 14 may be manufactured.

The present disclosure will now be described in further detail with reference to the following examples. These examples are for illustrative purposes only and are not intended to limit the scope of the disclosure.

### Example 1

### Synthesis of Toluene-4-Sulfonic Acid 3-Methyl-oxetane-3-yl Methyl Ester

Toluene-4-sulfonic acid 3-methyl-oxetan-3-yl methyl ester represented by Formula 16 below may be synthesized according to Scheme 1.

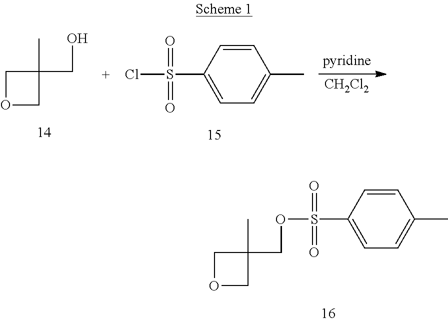

### Example 2

### Synthesis of Oxetane Containing Compound of Formula 2

The oxetane containing compound of Formula (2) may be synthesized according to Scheme 2.

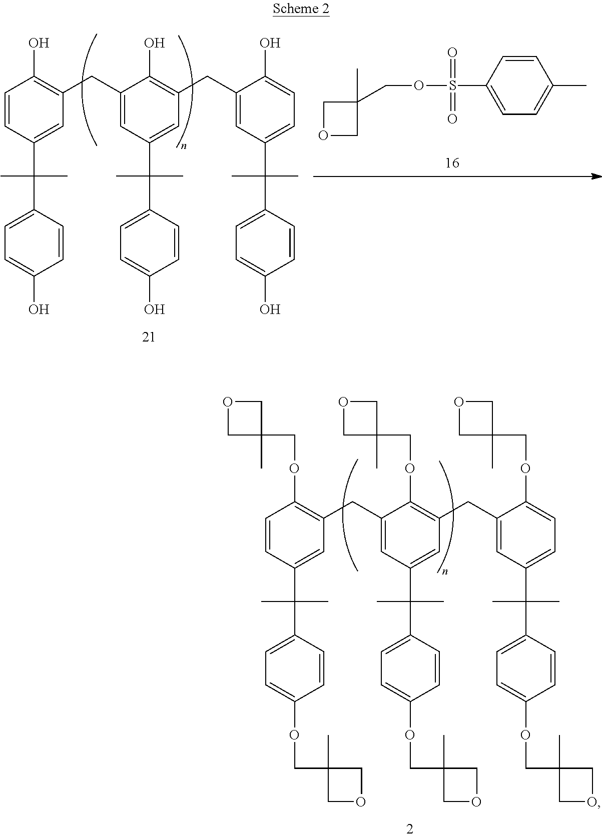

where n is 2.

### Example 3

### Preparation of the Composition for Forming a Glue Layer

2 g of PGMEA (available from AZ EM Co.), 5 g of SP-172 (available from Asahi Denka Korea Chemical Co.) and 5 g of glycerol (available from Aldrich) as an adhesion improving agent were placed in a jar and mixed together to prepare a solution. 48 g of the oxetane-containing compound of Formula (2) obtained in Example 2 was added to the jar and mixed with the solution for 24 hours on a roller before being used as a composition for forming a glue layer. The composition for forming a glue layer had a viscosity of about 1,000 cps at 25° C.

### Example 4

### Preparation of the Composition for Forming a Glue Layer

A composition for forming a glue layer was prepared in the same manner as in Example 3, except that glycerol as an adhesion improving agent was not used.

### Example 5

### Preparation of the Photosensitive Polymer Composition

30 g of PGMEA (available from AZ EM Co.) and 3 g of SP-172 (available from Asahi Denka Korea Chemical Co.) were placed in a jar and mixed together to prepare a solution. 40 g of the oxetane-containing compound of Formula 2 obtained in Example 2 was added to the jar and mixed with the solution for 24 hours on a roller before being used as a composition for forming a glue layer. The composition for forming a glue layer had a viscosity of about 2,000 cps at 25° C.

### Example 6

### Manufacture of an Inkjet Printhead Having the Structure Illustrated in FIG. 14

An insulating layer 112 formed of a silicon oxide to a thickness of about 2 μm, a tantalum nitride heater pattern 114 having a thickness of about 500 Å, an electrode pattern formed of an AlSiCu alloy in which the amounts of Si and Cu were respectively 1% by weight or less, to a thickness of about 500 Å, a silicon nitride passivation layer 118 having a thickness of about 3000 Å, and an anti-cavitation layer 119 formed of tantalum to have a thickness of about 3000 Å were sequentially formed on a 6-inch silicon wafer 110 using a sputtering process and photolithography process (refer to FIG. 3).

The silicon wafer 110 on which the layers were formed was heat treated at 200° C. for 10 minutes to remove moisture, and treated with hexamethyldisliazane (HMDS) as an adhesion promoter. The composition for forming a glue layer prepared in Example 3 was spin coated on the silicon wafer 110 at 2,000 rpm/40 sec, and soft-baked at 95° C. for 3 minutes. A light exposure process was performed with UV light of about 13 mW/cm² for 5 seconds using a negative photomask, and a PEB process was performed at 110° C. for 1 minute to form a pattern. The resultant was developed by using PGMEA as a developer for 30 seconds, rinsed using isopropyl alcohol (IPA), and dried. A post-bake process was conducted at 90° C. for 5 minutes and at 180° C. for 10 minutes, and the resultant was slowly cooled to form a glue layer 121 having a thickness of about 2 μm on the passivation layer 118 (refer to FIG. 3).

The photoresist polymer composition prepared in Preparation Example 4 was spin-coated on the glue layer 121 at 2000 rpm for 40 seconds, and baked at 95° C. for 7 minutes to form a first negative photoresist layer, i.e., the chamber material layer 120′, having a thickness of about 10 μm (refer to FIG. 4). As illustrated in FIG. 5, the first negative photoresist layer was exposed to i-line UV rays by using a first photomask having a predetermined ink chamber pattern and restrictor pattern. In this regard, the amount of exposure light was controlled to 130 mJ/cm². The wafer was baked at 95° C. for 3 minutes, immersed in a PGMEA developer for 1 minute for development, and then rinsed with isopropanol for 20 seconds. Thus, a chamber layer 120 was manufactured (refer to FIG. 5).

The passivation layer 118 and the insulating layer 112 were removed from a surface region of the silicon water (substrate) 110 where the ink feed hole was to be formed and from other regions of the substrate 110 (refer to FIG. 6).

As illustrated in FIG. 7, an imide-based positive photoresist (PW-1270, manufactured by TORAY Industries, Inc.) was spin-coated on the overall surface of the silicon wafer 110, on which the pattern of the chamber layer 120 was formed, at 1000 rpm for 40 seconds and baked at about 140° C. for 10 minutes to form a sacrificial layer S. The thickness of the sacrificial layer S was controlled so that the sacrificial layer S formed on the pattern of the chamber layer 120 had a thickness of about 5 μm.

The top surfaces of the pattern of the chamber layer 120 and the sacrificial layer S were planarized using a chemical mechanical polishing (CMP) process, as illustrated in FIG. 8. To this end, the silicon wafer 110 was placed onto a polishing pad such that the sacrificial layer S faced the polishing pad of a polishing plate (Model no.: JSR FP 8000, manufactured by JSR Co., Ltd.). The silicon wafer 110 was pressed by a press head on the polishing pad and a backing pad under a pressure of 10-15 kPa. The press head was rotated with respect to the polishing plate, while polishing slurries (POLIPLA 103, FUJIMI Corporation) were applied to the polishing pad. Each of the press head and the polishing pad was rotated at 40 rpm. The hacking pad was made of a material having a Shore D hardness of 30 to 70. The sacrificial layer S was planarized at an etch rate of 5 to 7 μm until the top surface of the pattern of the chamber layer 120 was removed by a thickness of about 1 μm.

A pattern of the nozzle layer 130 was formed on the silicon wafer 110, on which the pattern of the chamber layer 120 and the sacrificial layer S were formed, under the same conditions as for the formation of the pattern of the chamber layer 120 by using the photosensitive polymer composition prepared in Example 4 and a photomask (refer to FIGS. 9, 10, and 11).

As illustrated in FIGS. 12 and 13, an etch mask 140 for forming the ink feed hole 111 was formed on the bottom surface of the silicon wafer 110 by using conventional photolithography. A bottom surface region of the silicon wafer 110 exposed through the etch mask 140 was etched using a plasma etching process to form the ink feed hole 111, and the etch mask 140 was removed. In this regard, the power of a plasma etching device used was 2000 Watts, the etching gas was a mixture of sulfur hexafluoride (SF₆) and oxygen (O₂) (in a volume ratio of 10:1), and the etching rate was 3.7 μm/min.

Finally, the silicon wafer 110 was dipped in a methyl lactate solvent for 2 hours to remove the sacrificial layer S, thereby forming an ink chamber 122 and a restrictor 124 surrounded by the chamber layer 120 in the space formed due to the removal of the sacrificial layer S. The manufacture of an inkjet printhead having a structure illustrated in FIG. 14 was completed.

### Comparative Example

An inkjet printhead was manufactured in the same manner as in Example 6, except that the glue layer was formed of the composition for forming a glue layer prepared in Example 4.

### Pattern Evaluation

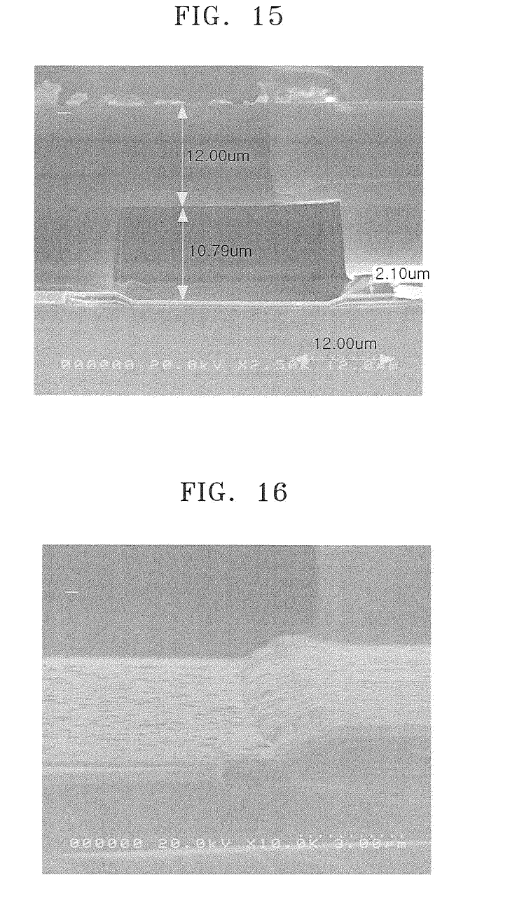

The composition for forming a glue layer obtained in Example 3 was spin-coated on a 6-inch silicon wafer at 300 rpm for 40 seconds and heated at 95° C. for 7 minutes to form a glue layer having a uniform thickness of about 10 μm. The glue layer was exposed to i-line light of about 260 mJ/cm² by using a Hg/Xe lamp exposure apparatus and then heated at 95° C. for 3 minutes. The glue layer was developed in PGMEA for 1 minute and then rinsed with isopropyl alcohol (IPA) for 10 seconds to form a pattern A. A scanning electron microscopic (SEM) image of the pattern A is shown in FIG. 15.

In addition, a pattern B was formed in the same manner as above, except that the composition for forming a glue layer obtained in Example 4 was used. A SEM image of the pattern B is shown in FIG. 16.

Referring to FIGS. 15 and 16, pattern A strongly adhered to the silicon wafer without being separated therefrom since the glue layer forming composition of Example 3 containing glycerol as an adhesion improving agent was used. However, pattern B formed from the glue layer forming composition of Example 4 excluding an adhesion improving agent was separated during the developing process.

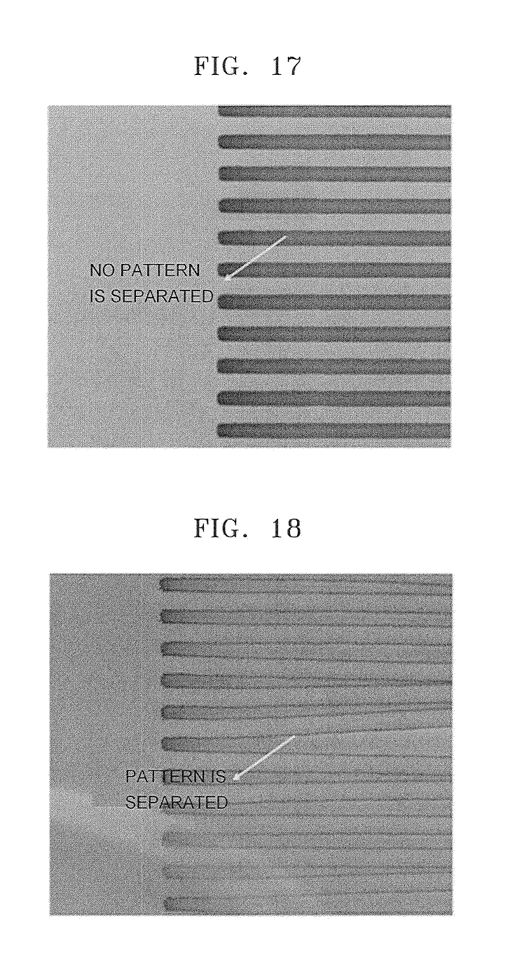

FIG. 17 is a SEM image from a surface of the heaters of an inkjet printhead manufactured using the disclosed photosensitive glue layer forming composition. In addition, an inkjet printhead may be manufactured by forming a glue layer pattern from a non-photosensitive glue layer forming composition (Himal, available from Hitachi Co., Ltd.), instead of using the photosensitive composition used in the present disclosure, and removing the composition remaining unused for the glue layer pattern by using a dry etching process. FIG. 18 is a SEM image from a surface of the heaters of the inkjet printhead manufactured using the conventional glue layer forming composition.

Referring to FIG. 17, the glue layer forming composition may be completely removed from the top surface of the heaters of the inkjet printhead. However, referring to FIG. 8, the non-photosensitive glue layer forming composition may remain on the heaters.

The glue layer forming composition may be a photocurable resin composition, unlike the conventional composition used to form the inkjet printhead illustrated in FIG. 18, so that the glue layer remaining unpatterned may be completely removed through the developing process. However, when the non-photosensitive composition is used, the glue layer remaining unpatterned may not be completely removed using the dry etching process. The unremoved residue of the non-photosensitive composition may contaminate ink or may cause an inkjet ejection failure. As described above, an inkjet printhead having excellent mechanical characteristics and adhesion to a substrate may be manufactured through a simple process. The inkjet printhead may have improved flexibility and may not be susceptible to cracking or failures caused by unnecessary composition residue.

While the present disclosure has been particularly shown and described with reference to several embodiments thereof, it will be understood by those of ordinary skill in the art that various changes in form and details may be made therein without departing from the spirit and scope of the present disclosure as defined by the following claims and their equivalents.

What is claimed is:

1. An inkjet printhead, comprising:
a substrate comprising an ink feed hole;
a chamber layer disposed on the substrate, the chamber layer comprising a plurality of ink chambers capable of being filled with ink supplied through the ink feed hole;
a nozzle layer disposed on the chamber layer, the nozzle layer comprising a plurality of nozzles through which ink may be ejected; and
a glue layer disposed between the substrate and the chamber layer,
wherein the glue layer comprises a cured product of an oxetane resin composition.

2. The inkjet printhead of claim 1, wherein the oxetane resin composition comprises an oxetane resin, a cationic photoinitiator, a solvent and an adhesion improving agent.

3. The inkjet printhead of claim 2, wherein the oxetane resin is represented by Formula (1): 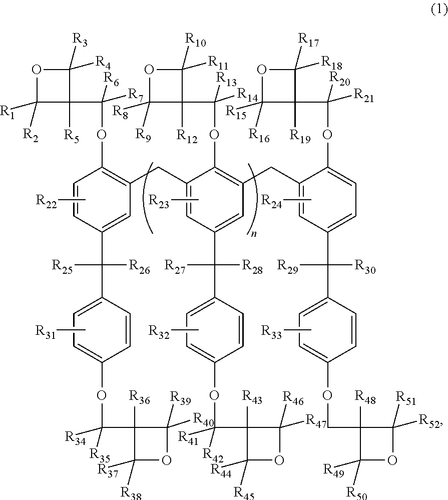
wherein n is an integer from 1 to 20, and
wherein R₁ through R₅₂ are each independently a halogen atom, a carboxyl group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₂-C₃₀ arylalkyl group, a substituted or unsubstituted C₅-C₃₀ heteroaryl group, or a substituted or unsubstituted C₃-C₃₀ heteroarylalkyl group.

4. The inkjet printhead of claim 2, wherein the oxetane resin is represented by Formula (2): 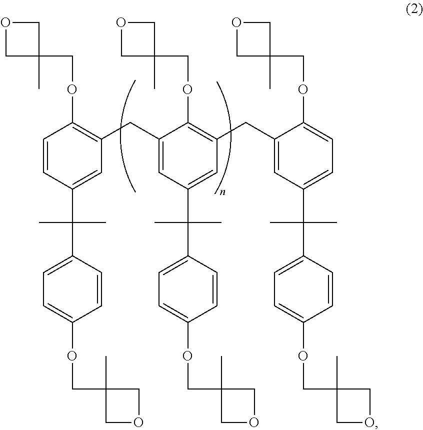
wherein n is an integer from 1 to 20.

5. The inkjet printhead of claim 2, wherein the cationic photoinitiator comprises an aromatic halonium salt or an aromatic sulfonium salt.

6. The inkjet printhead of claim 2, wherein the solvent comprises at least one solvent selected from the group consisting of α-butyrolactone, γ-butyrolactone, propylene glycol methyl ethyl acetate, tetrahydrofuran, methyl ethyl ketone, methyl isobutyl ketone, cyclopentanone, and xylene.

7. The inkjet printhead of claim 2, wherein the adhesion improving agent comprises a polyhydric alcoholic compound or a silane-based compound.

8. The inkjet printhead of claim 7, wherein the polyhydric alcoholic compound comprises at least one compound selected from the group consisting of trimethylolethane, trimethylolpropane, 2-methylpropanetriol, glycerol, a glycerol derivative, 1,2,5-pentanetriol, 1,2,4-butanetriol, pentaerythritol, dipentaerythritol, tripentaerythritol, sorbitol, 2-hydroxymethylpropane-1,3-diol, 2-methyl-1,2,4-butanetriol, 1,3,5-trihydroxymethylbenzene, 1,2,3,6-hexanetetrol, and 1,4-sorbitan, wherein the glycerol derivative comprises a compound represented by Formula (3): 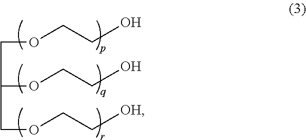
wherein p, q, and r are each independently an integer from 1 to 20.

9. The inkjet printhead of claim 7, wherein the silane-based compound comprises a compound represented by Formula (4): 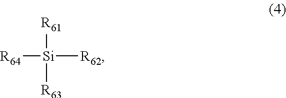
wherein R₆₁, R₆₂, R₆₃ and R₆₄ are each independently hydrogen, a halogen atom, a carboxyl group, an amino group, a nitro group, a cyano group, a substituted or unsubstituted C₁-C₂₀ alkyl group, a substituted or unsubstituted alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₇-C₃₀ arylalkyl group, a substituted or unsubstituted C₅-C₃₀ heteroaryl group, or a substituted or unsubstituted C₃-C₃₀ heteroarylalkyl group.

10. The inkjet printhead of claim 7, wherein the silane-based compound comprises at least one compound selected from the group consisting of glycidoxypropyltrimethoxysilane, glycidoxypropylmethyldimethoxysilane, glycidoxypropyldimethylethoxysilane, mercaptopropyltrimethoxysilane, γ-aminopropyltrimethoxysilane, γ-aminopropyltriethoxysilane, and N-(β-aminoethyl)-γ-aminopropyltrimethoxysilane.

11. The inkjet printhead of claim 2, wherein the oxetane resin composition comprises about 1 to about 20 parts by weight of a cationic photoinitiator, about 30 to about 300 parts by weight of a solvent and about 1 to about 20 parts by weight of an adhesion improving agent, based on 100 parts by weight of the oxetane resin.

12. The inkjet printhead of claim 1, wherein the chamber layer and the nozzle layer comprise cured products of a first photosensitive polymer composition and a second photosensitive polymer composition, respectively, and
wherein each of the first photosensitive polymer composition and the second photosensitive polymer composition comprises a prepolymer, a cationic photoinitiator and a solvent.

13. The inkjet printhead of claim 12, wherein the prepolymer has a glycidyl ether functional group, a ring-opened glycidyl ether functional group, or an oxetane functional group in a monomer repeating unit, and
wherein the prepolymer has a phenol novolac resin-based backbone, a bisphenol-A-based backbone, a bisphenol-F-based backbone, or an alicyclic backbone.

14. The inkjet printhead of claim 12, wherein the prepolymer comprises at least one selected from the group consisting of compounds expressed by Formulae (5) through (13): 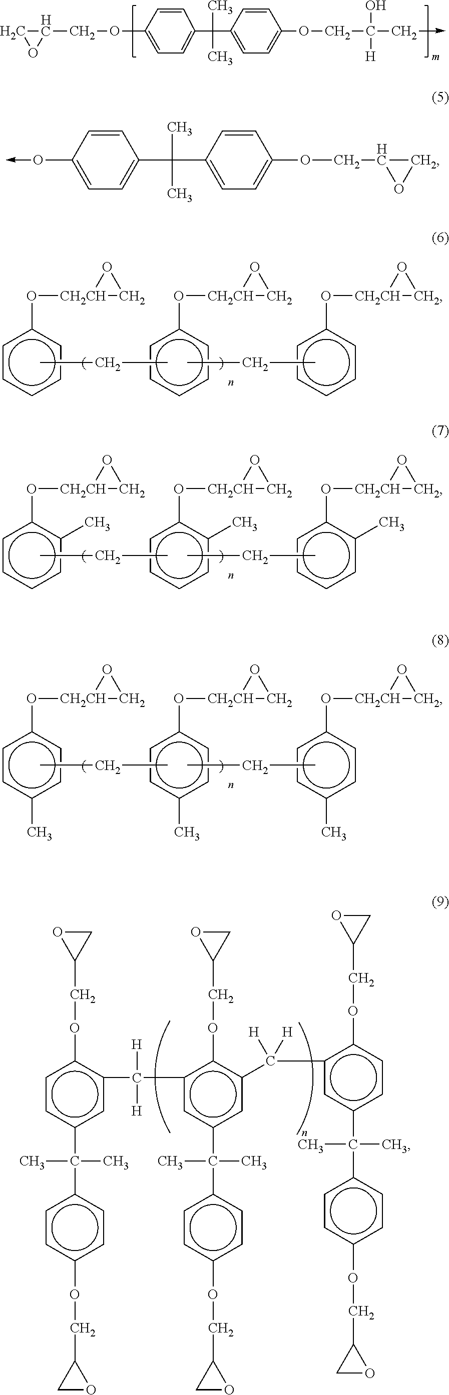 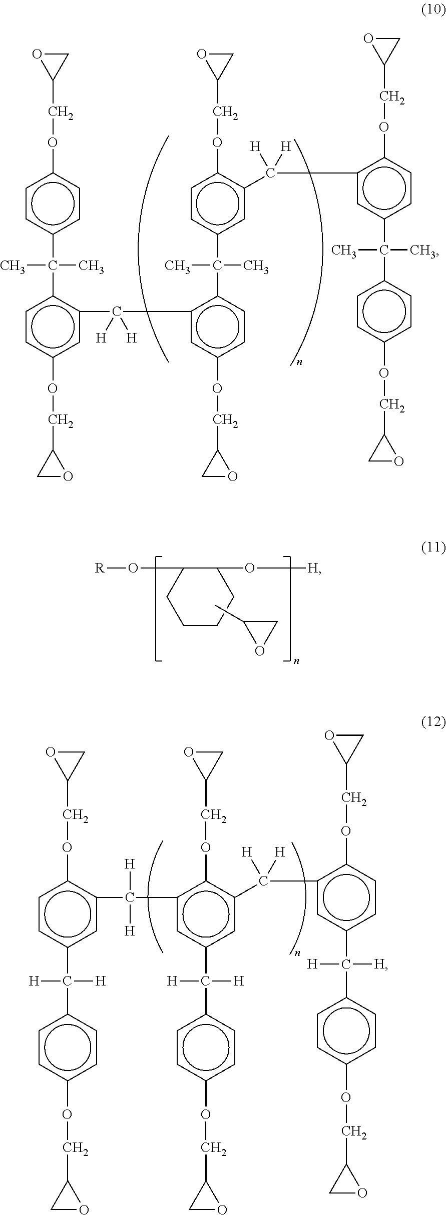 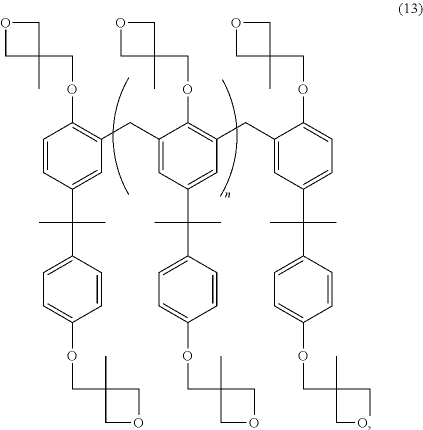
wherein m is an integer from 1 to 20, and n is an integer from 1 to 20.

15. The inkjet printhead of claim 1, further comprising:
an insulating layer disposed on the substrate;
a plurality of heaters and a plurality of electrodes sequentially disposed on the insulating layer; and
a passivation layer disposed to cover the plurality of heaters and the plurality of electrodes.

16. The inkjet printhead of claim 15, further comprising an anti-cavitation layer disposed on the passivation layer.

17. A method of manufacturing an inkjet printhead, comprising:
forming a glue layer on a substrate;
forming a chamber layer on the glue layer;
forming a nozzle layer comprising a plurality of nozzles on the chamber layer;
forming an ink feed hole from a bottom surface to a top surface of the substrate to penetrate the substrate; and
forming an ink chamber and a restrictor through the ink feed hole,
wherein the glue layer comprises a cured product of an oxetane resin composition.

18. The method of claim 17, wherein the oxetane resin composition comprises an oxetane resin, a cationic photoinitiator, a solvent and an adhesion improving agent.

19. The method of claim 18, wherein the oxetane resin is represented by Formula (1): 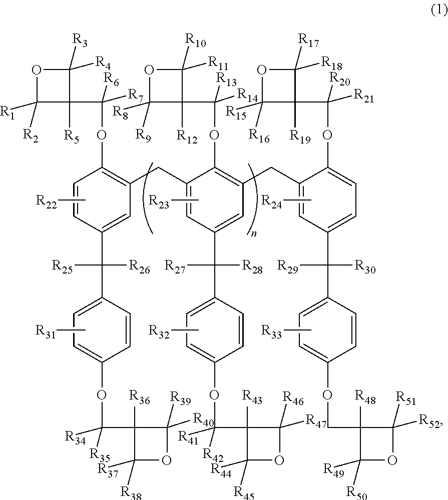
wherein n is an integer from 1 to 20, and
wherein R₁ through R₅₂ are each independently a halogen atom, a carboxyl group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₇-C₃₀ arylalkyl group, a substituted or unsubstituted C₅-C₃₀ heteroaryl group, or a substituted or unsubstituted C₃-C₃₀ heteroarylalkyl group.

20. The method of claim 18, wherein the adhesion improving agent comprises a polyhydric alcoholic compound or a silane-based compound.
